(19) United States
(12) Patent Application Publication
(10) Pub. No.: US 2024/0013233 A1
(43) Pub. Date: Jan. 11, 2024

(54) SYSTEMS AND METHODS TO IMPLEMENT PHYSICAL AND/OR BEHAVIORAL ATTRIBUTES THAT DEFINE A PERSONALITY ENTITY ASSOCIATED WITH A DIGITAL ASSET VIA A PHYSICAL OBJECT

(71) Applicant: Disney Enterprises, Inc., Burbank, CA (US)

(72) Inventors: Benjamin Lopez Barba, Rancho Cucamonga, CA (US); Alif Khalfan, Redwood City, CA (US); Zachary Shalett, Los Angeles, CA (US); Malcolm E. Murdock, Burbank, CA (US); Brianna Cochran, Los Angeles, CA (US)

(21) Appl. No.: 18/348,550

(22) Filed: Jul. 7, 2023

Related U.S. Application Data
(60) Provisional application No. 63/359,114, filed on Jul. 7, 2022.

(51) Int. Cl. G06Q 30/018; G06Q 20/38; G06Q 20/36

(52) U.S. Cl. CPC G06Q 30/018; G06Q 20/3829; G06Q 20/36; G06Q 20/389

(57) ABSTRACT

Systems and methods to implement physical and/or behavioral attributes that define a personality entity associated with a digital asset via a physical object are disclosed. Exemplary implementations may: determine physical and/or behavioral attributes associated with digital assets held by a digital wallet; receive output signals from sensors; determine, based on the output signals, interaction information; determine, based on the decentralized ledger and the address, changes in ownership of the digital assets; determine and effectuate adjustments to the physical and/or behavioral attributes based on the interaction information and the changes in ownership; transmit the adjustments to the physical object such that the physical object exemplifies the adjustments; receive an indication that the private portable device decoupled from the hardware coupler; and initiate, responsive to the indication, a wrap smart contract that is configured to link ownership rights to the digital assets in the digital wallet into a packaged digital asset.

### CROSS-REFERENCE TO RELATED APPLICATIONS

The present application claims priority benefit of the U.S. Provisional Patent Application No. 63/359,114 titled “SYSTEMS AND METHODS TO IMPLEMENT PHYSICAL AND/OR BEHAVIORAL ATTRIBUTES THAT DEFINE A PERSONALITY ENTITY ASSOCIATED WITH A DIGITAL ASSET VIA A PHYSICAL OBJECT” filed on Jul. 7, 2022, the contents of which are incorporated herein by reference in their entirety. The subject matter of this related application is hereby incorporated herein by reference.

### FIELD OF THE DISCLOSURE

The present disclosure relates to systems and methods to implement physical and/or behavioral attributes that define a personality entity associated with a digital asset via a physical object.

### BACKGROUND

Plush toys, action figures, dolls, and/or other objects that exemplify physical and/or behavioral attributes may be in possession of individuals for a period of time. During the period of time, the individuals may interact with the objects such as talk to them, play with them, travel with them, and/or other interactions that may contribute to wear and tear of the objects.

### SUMMARY

One aspect of the present disclosure relates to a system configured to implement physical and/or behavioral attributes that define a personality entity associated with a digital asset via a physical object. A user may possess a physical object that exemplified physical and/or behavioral attributes (e.g., doll, action figure). Sensors within the physical object may determine how the user interacts with the physical object and thus determine interaction information. The physical object may include a hardware coupler where a private portable device that stores a private key may provide access to an address on the decentralized ledger and thus a digital wallet. The digital wallet may hold one or more digital assets that are correlated to physical and/or behavioral attributes. Upon the private portable device being coupled with the physical article, the digital assets may be accessed to determine the correlated physical and/or behavioral attributes, and exemplify the physical and/or behavioral attributes. Additionally, based on the interaction information, other physical and/or behavioral attributes may be determined and exemplified by the physical article. All the physical and/or behavioral attributes for the physical article may be packaged and transferred to another physical article for the other physical article to exemplify upon decoupling the private portable device from the hardware coupler. Thus, a system that enables implementation of animate attributes amongst multiple physical objects instead of being confined to one physical article is provided. Additionally, the physical and/or behavioral attributes may be based on digital assets held in digital wallets, thus increasing acquisition and/or relinquishment of various digital assets recorded on a decentralized ledger while maintaining immutable ownership of such digital asset unless changed via transactions recorded on the decentralized ledger.

The system may include one or more hardware processors configured by machine-readable instructions, individual physical objects, decentralized ledger server(s), and/or other components. The individual physical objects may be configured to exemplify the physical and/or behavioral attributes. The individual physical objects may include a transmitter-receiver configured to communicate and receive information, a set of sensors configured to generate output signals that convey handling and use of the individual physical objects by a user, a hardware coupler configured to couple the individual physical objects with a private portable device that may store a private key, and/or other components. The private key may provide access to the digital wallet.

The machine-readable instructions may include one or more instruction components. The instruction components may include computer program components. The instruction components may include one or more of attribute determination component, interaction information determination component, ownership change determination component, adjustment component, wrap contract initiation component, and/or other instruction components.

The attribute determination component may be configured to determine physical and/or behavioral attributes associated with digital assets that are indicated by a digital wallet based on a decentralized ledger, an address on the decentralized ledger, and electronic storage. The digital wallet may be associated with the address. The digital wallet may indicate ownership of the digital assets that are correlated with the physical and/or behavioral attributes recorded in the electronic storage.

The interaction information determination component may be configured to receive output signals from a set of sensors. The interaction information determination component may be configured to determine, based on the output signals, interaction information. The interaction information may include vocal communication by the user with the physical object, physical touch by the user with the physical object, changes in location of the physical object, and/or changes in position of the physical object in locations.

The ownership change determination component may be configured to determine, based on the decentralized ledger and the address, changes in ownership of the digital assets. Changes in ownership may include acquisition of other digital assets associated with attributes and/or relinquishment of the digital assets.

The adjustment component may be configured to determine adjustments to the physical and/or behavioral attributes based on the interaction information and the changes in ownership. The adjustment component may be configured to effectuate the adjustments to the physical and/or behavioral attributes. The adjustment component may be configured to transmit the adjustments to the physical object such that the physical object implements and exemplifies the adjustments to the physical and/or behavioral attributes.

The wrap contract initiation component may be configured to receive an indication that the private portable device decoupled from the hardware coupler. The wrap contract initiation component may be configured to initiate, responsive to the indication, a wrap smart contract that is configured to link ownership rights to the digital assets in the digital wallet into a packaged digital asset such that the ownership rights to the digital assets in the digital wallet at the time of the indication are required be held by the same user. The digital wallet may indicate ownership of the packaged digital asset.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to implement physical and/or behavioral attributes that define a personality entity associated with a digital asset via a physical object, in accordance with one or more implementations.

FIG. 2 illustrates a method to implement physical and/or behavioral attributes that define a personality entity associated with a digital asset via a physical object, in accordance with one or more implementations.

FIG. 3A-B illustrates an example implementation of the system configured to implement physical and/or behavioral attributes that define a personality entity associated with a digital asset via a physical object, in accordance with one or more implementations.

### DETAILED DESCRIPTION

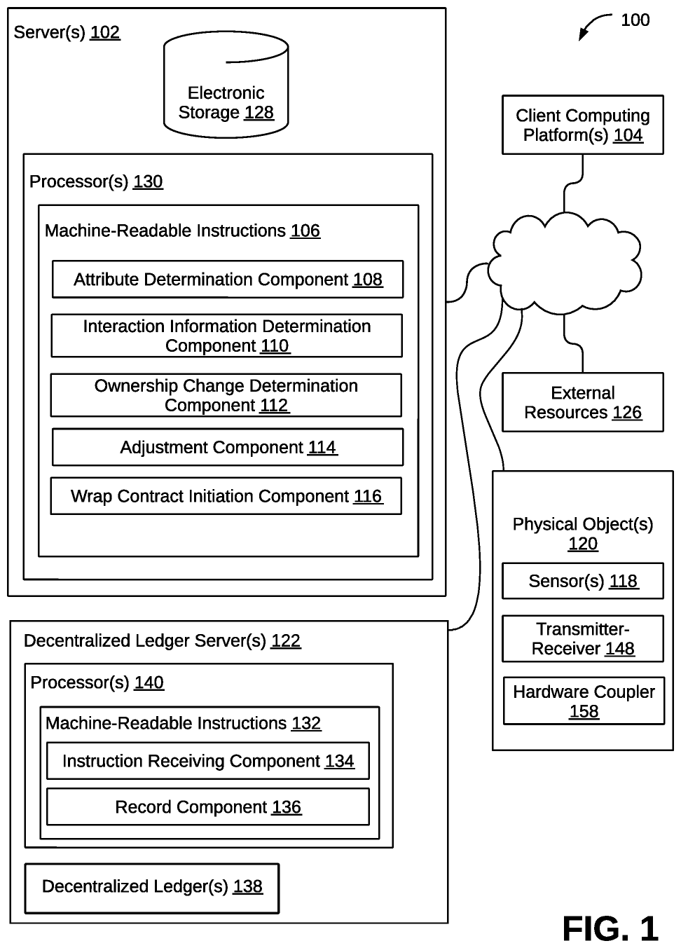

FIG. 1 illustrates a system 100 configured to implement physical and/or behavioral attributes that define a personality entity associated with a digital asset via a physical object 120, in accordance with one or more implementations. In some implementations, system 100 may include one or more servers 102, a set of sensors 118, physical object 120, decentralized ledger server(s) 122, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

As used herein, the term “digital asset” may refer to a unique identifier tracked on one or more permanent registries. The digital assets may be uniquely identified and/or uniquely identifiable. The unique identifier may include a set of numbers and/or alphabetic characters. As used herein, rights pertaining to digital assets may be tracked, recorded, and/or otherwise registered on one or more permanent registries. As such, an individual digital asset may be a registry-tracked digital asset.

Individual digital assets may be associated and/or correlated with another entity (which may be referred to as a “correlated entity”) by virtue of technology provided and/or supported by the one or more permanent registries on which the rights pertaining to the individual digital assets is tracked (including but not limited to smart contracts and/or other executable code on the one or more permanent registries). Accordingly, rights pertaining to a digital asset may correlate to the provision of one or more rights with respect to the correlated entity (e.g., control of the correlated entity and/or accessibility to the correlated entity). Transactions involving a digital asset recorded on a permanent registry may correlate to certain transactions (or modifications) of the correlated entity, and/or vice versa.

Various types and/or combinations of correlated entities are envisioned within the scope of this disclosure, including but not limited to physical article, virtual objects, content, rights, memberships, grants, etc. The use of the singular “entity” or “correlated entity” is not intended to be limiting, as multiple different objects, content, rights, memberships, grants, etc. may be correlated to a single digital asset. By way of non-limiting example, a correlated entity may be a physical article (e.g., artwork, a ticket to an event), a subscription to certain media content, content and so forth. The content may include an image, a video, a graphic image file, a signature of notoriety, a sound bite of an audio file, the audio file, attributes (physical and/or behavioral), and/or other content stored on the permanent registry and/or other electronic storage. In some implementations, the correlated entity may refer to any physical articles, virtual objects, content, rights, memberships, grants, etc. related to art and entertainment for which a user may use, own, sell, trade, loan, destroy, and/or otherwise effectuate a change of ownership, access, or control (including exchanges through challenges).

A digital asset may be fungible if it is functionally and/or physically indistinguishable from another digital asset. A digital asset may be non-fungible if it is unique, or one-of-a-kind. For example, a specific individual may be non-fungible. A digital asset may be semi-fungible if there is a set of a limited number of similar but distinguishable digital assets. For example, a limited amount of images of a sports team for a particular year may be semi-fungible. For example, a digital ticket to a show, concert, exhibition, and/or other events may be semi-fungible. The semi-fungible digital assets are considered as unique, “not fungible”, or non-fungible digital assets. In some implementations, the digital assets may include non-fungible tokens, fungible tokens, semi-fungible tokens, and/or other digital assets.

In some implementations, permanent registries, or decentralized ledger(s) 138, may be implemented by registry servers or decentralized ledger server(s) 122. The terms “permanent registries” and “decentralized ledgers” may be used interchangeably herein. The terms “registry servers” and “decentralized database servers” may be used interchangeably herein. In some implementations, one or more permanent registries may be decentralized and/or immutable registries. In some implementations, the one or more permanent registries may be one or more databases on which the rights pertaining to the individual digital assets are tracked and/or recorded. In some implementations, blockchains may be maintained by distributed computing platforms (not shown in FIG. 1). In some implementations, a distributed computing platform may be implemented by a set of client computing platform(s) 104 and/or servers (including, for example, one or more registry servers). The distributed computing platform may support a virtual machine (not shown in FIG. 1). The distributed computing platform and/or the virtual machine may form a runtime environment for smart contracts and/or other executable code. A distributed computing platform may include electronic storage configured to store part or all of individual blockchains. For example, the smart contracts may be stored on one or more blockchains, and/or another permanent registry. In some implementations, the distributed computing platform may be the EOSIO platform. In some implementations, the distributed computing platform may be similar to or based on the EOSIO platform. In some implementations, the distributed computing platform may be Ethereum. In some implementations, the distributed computing platform may be similar to or based on Ethereum. In some implementations, the virtual machine may be a distributed and/or decentralized virtual machine.

In some implementations, at least one of the permanent registries may be a private permissioned permanent registry (e.g., a private permissioned blockchain). The private permissioned permanent registry may be configured to record information and/or track addresses (e.g., corresponding to digital wallets, smart contracts, etc.). The recorded information may include rights pertaining to the digital assets. For example, ownership rights and/or other accessibility may be modified. In some implementations, the ownership rights and/or other rights may be indicated by addresses that correspond to digital wallets of users tracked and recorded by the permanent registries on the registry servers and transaction information recorded on the permanent registries. In some implementations, a digital asset may be removed from one permanent registry and added or recorded on another permanent registry. In some implementations, at least one of the permanent registries implemented by the registry servers is a public permanent registry (e.g., a public blockchain). The public permanent registry may be configured to be part of either EOSIO mainnet, Ethereum mainnet, Ethereum 1.5, Ethereum 2.0, a derivative of Ethereum 2.0 that is configured to perform transactions of Ether (ETH) between accounts, or a derivative of EOSIO that is configured to perform transactions of EOS between different accounts.

Elements of a blockchain or another permanent registry may be grouped together in units that are referred to as blocks. For example, an individual block may include one or more digital assets and one or more transactions. For example, an individual block may be linked to one or more other individual blocks. Individual blocks may be linked or chained together to form a structure of blocks and/or a hierarchy of blocks, such as, e.g., a chain of blocks. An individual block may include one or more digital assets, one or more transactions, smart contracts, and/or other information.

In some implementations, one or more permanent registries implemented by the registry servers may be publicly accessible. In some implementations, for example, the one or more databases may be accessible via a mobile application or a website. In some implementations, one or more permanent registries implemented by the registry servers may be private and/or permissioned. In some implementations, one or more permanent registries implemented by the registry servers may be append-only. In some implementations, existing blocks of one or more permanent registries implemented by the registry servers can substantially not be altered or deleted, unless multiple copies are altered. This is unlikely to happen provided that the multiple copies are stored on different computing platforms, e.g., in different geographical locations. Permanent registries may be replicated on multiple computing platforms, preferably in multiple different geographical locations. Additionally, individual blocks may be linked together in a manner that prevents tampering, such as, e.g., using a hash chain and/or digital signatures. In particular, hash values may be generated using fixed-output-length one-way hashing functions that take variable-length input, and may be effectively impossible (or, at least, computationally infeasible) to reverse. As such, a hashing function may provide one-way encryption. By way of non-limiting example, the hashing function may be SHA-256, BLAKE2, SHAKE256, and/or another hashing function. Contents of individual blocks, transactions, and/or articles may be digitally signed in a manner that proves integrity and/or prevents tampering, e.g., by providing authentication, as well as non-repudiation.

The decentralized ledger server(s) 122 may include one or more of processor(s) 140, machine-readable instructions 132, decentralized ledger(s) 138, electronic storage (not illustrated), and/or other components. The electronic storage may be similar to electronic storage 128 as described elsewhere in this disclosure, though included in the decentralized ledger server(s) 122. Machine-readable instructions 132 may include one or more instruction components. The instruction components may include computer program components. The instruction components may include one or more of an instruction receiving component 134, a record component 136, and/or other instruction components. Processor(s) 140 may be similar to processor(s) 130 as described elsewhere in this disclosure, though included in the decentralized ledger server(s) 122. Machine-readable instructions 132 may be similar to machine-readable instructions 106 as described elsewhere in this disclosure, though included in decentralized ledger server(s) 122.

Instruction receiving component 134 may be configured to receive (sets of) instructions to add, modify, analyze, and/or remove recorded information (e.g., rights) in the decentralized ledger(s) 138. For example, instruction receiving component 134 may receive one or more sets of instructions from other components of system 100. Instruction receiving component 134 may provide received sets of instructions to the record component for execution. In some implementations, instruction receiving component 134 may be arranged, organized, and/or otherwise included in the decentralized ledger server(s) 122 and/or the decentralized ledger(s) 138.

Record component 136 may be configured to record information, including but not limited to ownership rights pertaining to the digital assets correlated with entitles, e.g., on one or more permanent ledgers such as the decentralized ledger(s) 138. In some implementations, record component 136 may add, modify, analyze, and/or remove recorded information.

Individual physical objects 120 may be configured to exemplify the physical and/or behavioral attributes. Physical objects 120 may include an action figure, a stuffed animal, a toy vehicle (e.g., racecar, monster truck), a portable computing device (e.g., tablet computer), and/or other physical objects. Physical objects 120 may include set of sensors 118, a transmitter-receiver 148, hardware coupler 158, and/or other components. Transmitter-receiver 148 may be configured to communicate and receive information. Set of sensors 118 may be configured to generate output signals that convey handling and use of individual physical objects 120 by a user. Hardware coupler 158 may be configured to couple individual physical objects 120 with a private portable device that may store a private key. Hardware coupler 158 may read the private key. The private portable device may be, for example, be a universal serial bus (USB), a secure digital (SD) memory card, and/or other private portable device that may store the private key. The private key may provide access to a digital wallet that is associated with an address on decentralized ledger(s) 138. That is, based on the private key, physical object 120 may have access to the digital wallet. The digital wallet may indicate ownership of digital assets that are correlated with the physical and/or behavioral attributes. The physical and/or behavioral attributes may be recorded in electronic storage 128, decentralized ledger(s) 138, and/or other electronic storage.

Thus, in some implementations, adjustment component 114 may be configured to communicate with electronic storage 128 to determine the physical and/or behavioral attributes. In some implementations, the physical and/or behavioral attributes and/or the adjustments thereof may be recorded on decentralized ledger(s) 138 and adjustment component 114 may be configured to read decentralized ledger(s) 138 to determine the physical and/or behavioral attributes.

Set of sensors 118 configured to generate output signals that that convey handling and use of individual physical objects 120 by a user. By way of non-limiting example, set of sensors 118 may include an orientation sensor, a location sensor, a distance sensor, an audio sensor, a pressure sensor, light sensor, and/or other sensor(s). Handling and use of individual physical objects 120 may include, but not limited to, talking to physical objects 120, playing with physical objects 120, sleeping with physical objects 120, eating with physical objects 120, traveling with physical objects 120 (e.g., to amusement parks, to doctor appointments) and/or other handling and use. The handling and use of individual physical objects 120 conveyed by the output signals generated by set of sensors 118 may be defined in the interaction information described herein.

The orientation sensor may be configured to generate output signals conveying orientation information and/or other information. Orientation information derived from output signals of an orientation sensor may define an orientation of physical object 120. In some implementations, orientation may refer to one or more of a pitch angle, a roll angle, a yaw angle, heading, pointing direction, and/or other measurements. An orientation sensor may include an inertial measurement unit (IMU) such as one or more of an accelerometer, a gyroscope, a magnetometer, Inclinometers, Electronic nose, Infrared Imagers, Micro-bolometers, micro-displays (DMD), Digital micro-mirror device, Optical Switches, and/or other devices.

The location sensor may be configured to generate output signals conveying location information and/or other information. Location information derived from output signals of a location sensor may define one or more of a geo-location of physical object 120, an elevation of physical object 120, and/or other measurements. A location sensor may include one or more of a global positioning system (GPS), an altimeter, and/or other devices.

The audio input sensor may be configured to receive audio input. An audio input sensor may include a sound transducer and/or other sensor configured to convert sound (e.g., air pressure variation) into an electrical signal. By way of non-limiting illustration, an audio input sensor may include a microphone.

The pressure sensor may be configured to generate output signals conveying pressure information and/or other information. Pressure information derived from output signals of a pressure sensor may define a force per unit area imparted to the pressure sensor. A pressure sensor may include one or more of a piezoresistive strain gauge, a capacitive pressure sensor, an electromagnetic pressure sensor, a piezoelectric sensor, a strain-gauge, and/or other pressure sensors.

The light sensor may be configured to generate output signals conveying ambient light information and/or other information. The ambient light information derived from output signals of a light sensor may define intensity and/or presence (or absence) of light or other electromagnetic radiation incident on the light sensor. A light sensor may include one or more of a photodiode, an active-pixel sensor, photovoltaic, and/or other sensors.

Server(s) 102 may be configured by machine-readable instructions 106. Machine-readable instructions 106 may include one or more instruction components. The instruction components may include computer program components. The instruction components may include one or more of attribute determination component 108, interaction information determination component 110, ownership change determination component 112, adjustment component 114, wrap contract initiation component 116, and/or other instruction components.

Attribute determination component 108 may be configured to determine the physical and/or behavioral attributes associated with the digital assets that are indicated by the digital wallet. The determination may be based on a decentralized ledger, an address on decentralized ledger(s) 138, electronic storage 128, and/or other information. In some implementations, physical and/or behavioral attributes may comprise personality entities that physical objects 120 exemplify. A personality entity may include one or more of the physical and/or behavioral attributes. By way of non-limiting example, the physical and/or behavioral attributes may include an eye color, a voice, one more phrases, one or more movements, a skin color, one or more sound effects, and/or other physical and/or behavioral attributes. The movements may include head rotation, limb rotation (e.g., arms, hands), limb hinging, ear folding, eye blinking, mouth opening and closing, smiling, nose shaking, tail wagging, and/or other movements. The sound effects may include animal noises, grunting, screaming, laughing, crying, and/or other sound effects. The voice may be deep, low pitched, high pitched, and/or other voice variations, and/or have an accent.

Interaction information determination component 110 may be configured to receive the output signals from set of sensors 118. Interaction information determination component 110 may be configured to determine, based on the output signals, interaction information. The interaction information may characterize how, when, where, and why the user interacts with physical object 120. By way of non-limiting example, the interaction information may include vocal communication by the user with physical object 120, physical touch by the user with physical object 120, changes in location of physical object 120, changes in position of physical object 120 in locations, and/or other interactions. By way of non-limiting example, the physical touch may include hugging, kissing, petting, hitting, squeezing, cradling, and/or other physical touch. In some implementations, interaction information determination component 110 may be configured to determine what the user is saying to and/or near physical object 120 by way of novel and/or known speech recognition techniques.

Ownership change determination component 112 may be configured to determine, based on decentralized ledger(s) 138 and the address, changes in ownership of the digital assets. Changes in ownership may include acquisition of other digital assets correlated with the physical and/or behavioral attributes and/or relinquishment of the digital assets correlated with the physical and/or behavioral attributes. The other digital assets may be associated with novel or known physical and/or behavioral attributes. The acquisition of the digital assets may include receiving, purchasing, trading, or otherwise obtaining the ownership rights of the digital assets so that the user is established or recorded as the owner/holder of the ownership rights. The relinquishment of the digital assets may include selling, trading, gifting, or otherwise changing the ownership of the digital assets so that the user is not established or recorded as the owner/holder of the ownership rights.

Adjustment component 114 may be configured to determine adjustments to the physical and/or behavioral attributes based on the interaction information and the changes in ownership. That is, how physical object 120 physically appears and/or behaviors, given the physical and/or behavioral attributes it already exemplifies, may be adjusted based on the interaction information. For example, a brown eye color may get lighter or turn green, the voice of physical object 120 may get deeper, and/or the phrases physical object 120 utters may be personalized to the user.

Adjustment component 114 may be configured to effectuate the adjustments to the physical and/or behavioral attributes. Thus, the physical and/or behavioral attributes stored in electronic storage 128, decentralized ledger(s) 138, and/or other electronic storage may be updated.

Adjustment component 114 may be configured to transmit the adjustments to physical object 120 such that physical object 120 implements and exemplifies the adjustments to the physical and/or behavioral attributes. Transmission of the adjustments and/or the physical and/or behavioral attributes themselves may be enabled based on wireless communication (e.g., transmitter-receiver 148), hardware communication (e.g., hardware coupler 158), Bluetooth communication, and/or other communication with electronic storage 128 that stores the physical and/or behavioral attributes. In some implementations, subsequent to the transmission, the physical and/or behavioral attributes may be locally stored in electronic storage within physical object 120.

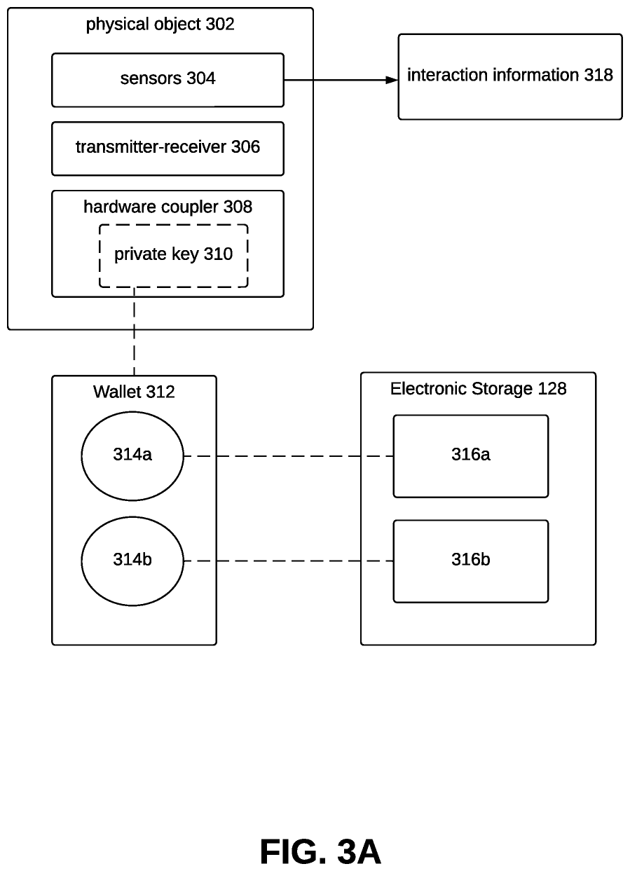

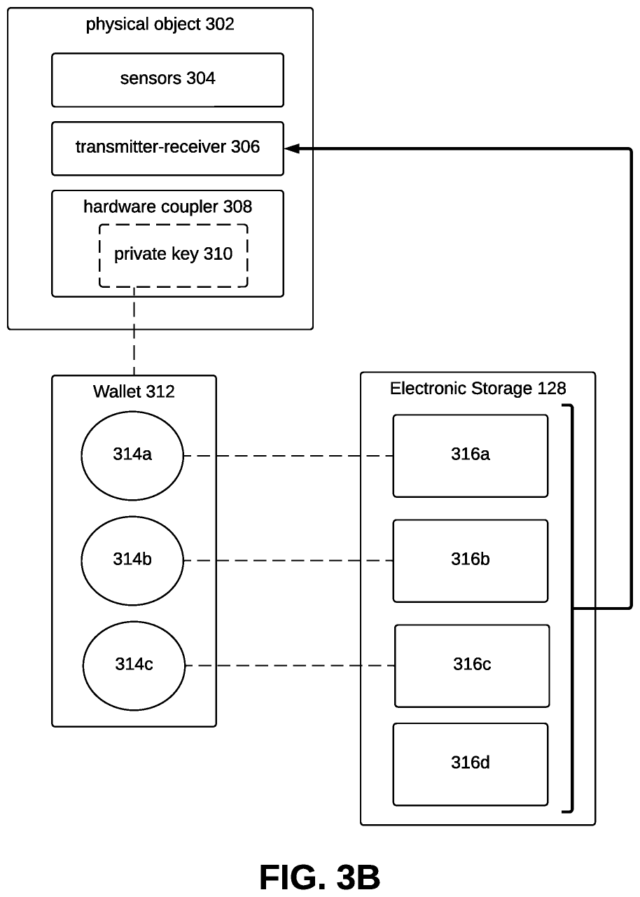

FIG. 3A illustrates a physical object 302 that includes sensors 304, transmitter-receiver 306, and hardware coupler 308. Hardware coupler 308 may store a private key 310 that provides access to a wallet 312 and control of digital assets held in wallet 312. Wallet 312 may hold digital assets 314a and 314b. Digital assets 314a and 314b may be correlated with physical and/or behavioral attributes 316a and 316b, respectively, stored in electronic storage 128 (the same in FIG. 1). Sensors 304 may be configured to detect handling and use of physical object 302 by a user and thus facilitate determination of interaction information 318.

FIG. 3B illustrates the same physical article 302 at in FIG. 3A, components thereof, wallet 312, digital assets thereof, electronic storage 128, and physical and/or behavioral attributes thereof. Wallet 312 may additionally include a new digital asset 314c that is correlated to physical and/or behavioral attribute 316c stored in electronic storage 128. Wallet 312 may include digital asset 314c by way of purchase, trading, or other acquisition. Based on interaction information 318 (illustrated in FIG. 3B), physical and/or behavioral attribute 316d may be determined and stored in electronic storage 128. Physical and/or behavioral attributes 316a-d may be transmitted to physical object 302 via a network (not illustrated) and transmitter-receiver 306 so that physical object 302 may exemplify physical and/or behavioral attribute 316a-d.

Referring to FIG. 1, wrap contract initiation component 116 may be configured to receive an indication that the private portable device decoupled from hardware coupler 158. Responsive to the indication, wrap contract initiation component 116 may be configured to initiate a wrap smart contract. The wrap smart contract may be configured to link ownership rights to the digital assets in the digital wallet into a packaged digital asset. The packaged digital asset may reference the digital assets in the digital wallet. The wrap smart contract may specify that ownership rights/ownership to two or more digital assets changes upon the ownership rights to one of the two or more digital assets changing, and/or other information. Thus, the two or more digital assets may be linked. The wrap smart contract may be recorded on decentralized ledger(s) 138. In some implementations, the wrap smart contract may include minting the packaged digital asset, if not already, that references the two or more digital assets. As such, the ownership to the digital assets in the digital wallet at the time of the indication are required be held by the same user thereafter. The digital wallet may hold the packaged digital asset and thus indicate ownership of the packaged digital asset. The package digital asset may be correlated with all the physical and/or behavioral attributes that the two or more linked digital assets are correlated with. Coupling of the private portable device with hardware coupler 158 of another physical object 120 or the same physical object 120 may effectuate exemplification of the physical and/or behavioral attributes associated with the packaged digital asset to provide new interaction experiences with that physical object 120 which are based on prior interactions with physical objects 120 by way of the packaged digital asset and the correlated physical and/or behavioral attributes.

As used herein, the word “mint” may refer to performance, initiating, and/or execution of the process(es), transaction(s), procedure(s), operation(s), and/or step(s) that result in the instantiation of a given digital asset, including the establishment of ownership, and definition of appearance of the given digital asset (e.g., the packaged digital asset). Minting the given digital asset may include generating the given digital asset record for a given composition entity. In some implementations, minting the given digital asset may include building an executable program. The executable program to be transmitted to a distributed computing platform(s) capable of executing the program. In some implementations, execution of the program by the distributed computing platform may display the correlated given composition entity, i.e., the physical and/or behavioral attributes, on the distributed platforms. In some implementations, the given digital asset record may include such values that define the given composition entity. In some implementations, the given digital asset record may be recorded at an address on decentralized ledger(s) 138 in a smart contract and/or other executable code. The given digital asset record may include information pertaining to the minted given digital asset, not limited to what defines the given composition entity.

In some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, and/or 116, and/or other components. Processor(s) 140 may be configured to execute components 134 and/or 136, and/or other components. Processor(s) 130 may be configured to execute components 108, 110, 112, 114, and/or 116, and/or other components and processor(s) 140 may be configured to execute components 134 and/or 136, and/or other components by software; hardware; firmware; some combination of software, hardware, and/or firmware; and/or other mechanisms for configuring processing capabilities on processor(s) 130 and processor(s) 140, respectively. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and/or 116 and components 134 and/or 136 are illustrated in FIG. 1 as being implemented within single separate processing units, in implementations in which processor(s) 130 and processor(s) 140 include multiple processing units, one or more of components 108, 110, 112, 114, and/or 116 may be implemented remotely from the other components and components 134 and/or 136 may be implemented remotely from the other components, respectively.

The description of the functionality provided by the different components 108, 110, 112, 114, 116, 134, and/or 136 described below is for illustrative purposes, and is not intended to be limiting, as any of components 108, 110, 112, 114, 116, 134, and/or 136 may provide more or less functionality than is described. For example, one or more of components 108, 110, 112, 114, 116, 134, and/or 136 may be eliminated, and some or all of its functionality may be provided by other ones of components 108, 110, 112, 114, 116, 134, and/or 136. As another example, processor(s) 130 and processor(s) 140 may be configured to individually execute one or more additional components that may perform some or all of the functionality attributed below to one of components 108, 110, 112, 114, 116, and one of components 134 and/or 136, respectively.

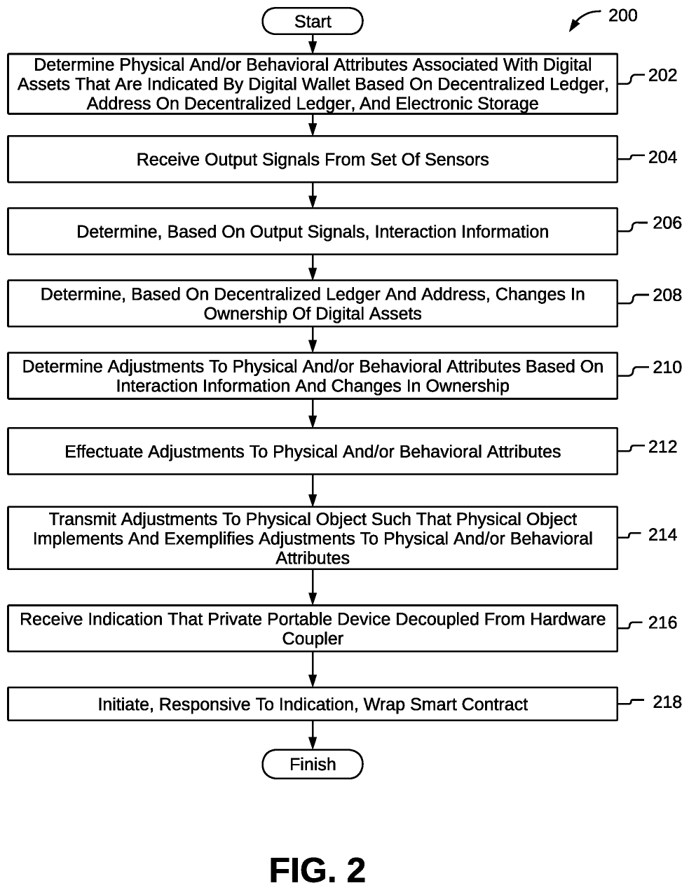

FIG. 2 illustrates a method 200 to implement physical and/or behavioral attributes that define a personality entity associated with a digital asset via a physical object, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include determining physical and/or behavioral attributes associated with digital assets that are indicated by a digital wallet based on a decentralized ledger, an address on the decentralized ledger, and electronic storage. The digital wallet may be associated with the address. The digital wallet may indicate ownership of the digital assets that are correlated with the physical and/or behavioral attributes recorded in the electronic storage. Operation 202 may be performed by one or more hardware processors configured by machine-readable instructions including a component that is the same as or similar to attribute determination component 108, in accordance with one or more implementations.

An operation 204 may include receiving output signals from a set of sensors. Individual physical objects configured to exemplify the physical and/or behavioral attributes may include a transmitter-receiver configured to communicate and receive information, the set of sensors configured to generate output signals that convey handling and use of the individual physical objects by a user, a hardware coupler configured to couple the individual physical objects with a private portable device that may store a private key. The private key may provide access to the digital wallet. Operation 204 may be performed by one or more hardware processors configured by machine-readable instructions including a component that is the same as or similar to interaction information determination component 110, in accordance with one or more implementations.

An operation 206 may include determining, based on the output signals, interaction information. Operation 206 may be performed by one or more hardware processors configured by machine-readable instructions including a component that is the same as or similar to interaction information determination component 110, in accordance with one or more implementations.

An operation 208 may include determining, based on the decentralized ledger and the address, changes in ownership of the digital assets. Operation 208 may be performed by one or more hardware processors configured by machine-readable instructions including a component that is the same as or similar to ownership change determination component 112, in accordance with one or more implementations.

An operation 210 may include determining adjustments to the physical and/or behavioral attributes based on the interaction information and the changes in ownership. Operation 210 may be performed by one or more hardware processors configured by machine-readable instructions including a component that is the same as or similar to adjustment component 114, in accordance with one or more implementations.

An operation 212 may include effectuating the adjustments to the physical and/or behavioral attributes. Operation 212 may be performed by one or more hardware processors configured by machine-readable instructions including a component that is the same as or similar to adjustment component 114, in accordance with one or more implementations.

An operation 214 may include transmitting the adjustments to the physical object such that the physical object implements and exemplifies the adjustments to the physical and/or behavioral attributes. Operation 214 may be performed by one or more hardware processors configured by machine-readable instructions including a component that is the same as or similar to adjustment component 114, in accordance with one or more implementations.

An operation 216 may include receiving an indication that the private portable device decoupled from the hardware coupler. Operation 216 may be performed by one or more hardware processors configured by machine-readable instructions including a component that is the same as or similar to wrap contract initiation component 116, in accordance with one or more implementations.

An operation 218 may include initiating, responsive to the indication, a wrap smart contract that is configured to link ownership rights to the digital assets in the digital wallet into a packaged digital asset such that the ownership rights to the digital assets in the digital wallet at the time of the indication are required be held by the same user. The digital wallet may indicate ownership of the packaged digital asset. Operation 218 may be performed by one or more hardware processors configured by machine-readable instructions including a component that is the same as or similar to wrap contract initiation component 116, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to implement physical and/or behavioral attributes that define a personality entity associated with a digital asset via a physical object, the system comprising:
physical objects configured to exemplify physical and/or behavioral attributes, wherein individual ones of the physical objects include:
a transmitter-receiver configured to communicate and receive information;
a set of sensors configured to generate output signals that convey handling and use of the individual physical objects by a user;
hardware coupler configured to couple the individual physical objects with a private portable device that stores a private key, wherein the private key provides access to a digital wallet that is associated with an address on a decentralized ledger, wherein the digital wallet indicates ownership of digital assets that are correlated with the physical and/or behavioral attributes recorded in electronic storage;
one or more processors configured by machine-readable instructions to:
determine based on the decentralized ledger, the address, and the electronic storage, the physical and/or behavioral attributes associated with the digital assets that are indicated by the digital wallet;
receive the output signals from the set of sensors;
determine, based on the output signals, interaction information, wherein the interaction information includes vocal communication by the user with the physical object, physical touch by the user with the physical object, changes in location of the physical object, and/or changes in position of the physical object in locations;
determine, based on the decentralized ledger and the address, changes in ownership of the digital assets, wherein changes in ownership include acquisition of other digital assets associated with the physical and/or behavioral attributes and/or relinquishment of the digital assets;
determine adjustments to the physical and/or behavioral attributes based on the interaction information and the changes in ownership;
effectuate the adjustments to the physical and/or behavioral attributes;
transmit the adjustments to the physical object via the transmitter-receiver such that the physical object implements and exemplifies the adjustments to the physical and/or behavioral attributes;
receive an indication that the private portable device decoupled from the hardware coupler; and
initiate, responsive to the indication, a wrap smart contract that is configured to link ownership rights to the digital assets in the digital wallet into a packaged digital asset such that the ownership to the digital assets in the digital wallet at the time of the indication are required be held by the same user, wherein the digital wallet indicates ownership of the packaged digital asset.

2. The system of claim 1, wherein coupling of the private portable device with the hardware coupler of another physical object effectuates exemplification of the physical and/or behavioral attributes associated with the packaged digital asset.

3. The system of claim 1, wherein the set of sensors includes one or more of an audio input sensor, a pressure sensor, a location sensor, and/or a light sensor.

4. The system of claim 1, wherein the physical and/or behavioral attributes include an eye color, a voice, one more phrases, one or more movements, a skin color, and/or one or more sound effects.

5. The system of claim 1, wherein the electronic storage is separate from the decentralized ledger, wherein the one or more processors are further configured by the machine-readable instructions to communicate with the electronic storage.

6. The system of claim 1, wherein the electronic storage is the decentralized ledger such that the adjustment to the physical and/or behavioral attributes are recorded on the decentralized ledger.

7. A method to implement physical and/or behavioral attributes that define a personality entity associated with a digital asset via a physical object, the method comprising:
determining physical and/or behavioral attributes associated with digital assets that are held in a digital wallet based on a decentralized ledger, an address on the decentralized ledger, and electronic storage, wherein the digital wallet is associated with the address, wherein the digital wallet indicates ownership of the digital assets that are correlated with the physical and/or behavioral attributes recorded in the electronic storage;
receiving output signals from a set of sensors, wherein individual physical objects configured to exemplify the physical and/or behavioral attributes include a transmitter-receiver configured to communicate and receive information, the set of sensors configured to generate the output signals that convey handling and use of the individual physical objects by a user, a hardware coupler configured to couple the individual physical objects with a private portable device that stores a private key, wherein the private key provides access to the digital wallet;
determining, based on the output signals, interaction information, wherein the interaction information includes vocal communication by the user with the physical object, physical touch by the user with the physical object, changes in location of the physical object, and/or changes in position of the physical object in locations;
determining, based on the decentralized ledger and the address, changes in ownership of the digital assets, wherein changes in ownership include acquisition of other digital assets associated with the physical and/or behavioral attributes and/or relinquishment of the digital assets;
determining adjustments to the physical and/or behavioral attributes based on the interaction information and the changes in ownership;
effectuating the adjustments to the physical and/or behavioral attributes stored in the electronic storage;
transmitting the adjustments to the physical object via the transmitter-receiver such that the physical object implements and exemplifies the adjustments to the physical and/or behavioral attributes;
receiving an indication that the private portable device decoupled from the hardware coupler; and
initiating, responsive to the indication, a wrap smart contract that is configured to link ownership rights to the digital assets in the digital wallet into a packaged digital asset such that the ownership to the digital assets in the digital wallet at the time of the indication are required be held by the same user, wherein the digital wallet indicates ownership of the packaged digital asset.

8. The method of claim 7, wherein coupling of the private portable device with the hardware coupler of another physical object effectuates exemplification of the physical and/or behavioral attributes associated with the packaged digital asset.

9. The method of claim 7, wherein the set of sensors includes one or more of an audio input sensor, a pressure sensor, a location sensor, and/or a light sensor.

10. The method of claim 7, wherein the physical and/or behavioral attributes include an eye color, a voice, one more phrases, one or more movements, a skin color, and/or one or more sound effects.

11. The method of claim 7, wherein the electronic storage is separate from the decentralized ledger, wherein the one or more processors are further configured by the machine-readable instructions to communicate with the electronic storage.

12. The method of claim 7, wherein the electronic storage is the decentralized ledger such that the adjustment to the physical and/or behavioral attributes are recorded on the decentralized ledger.
